(19) United States
(12) Patent Application Publication
(10) Pub. No.: US 2004/0168363 A1
(43) Pub. Date: Sep. 2, 2004

(54) Pod device for animal repellent

(76) Inventor: Stanley Z. Baker, St. Petersburg, FL (US)

Correspondence Address: D. Peter Hochberg, D. Peter Hochberg Co., L.P.A., 6th Floor, 1940 East 6th Street, Cleveland, OH, 44114, US

(21) Appl. No.: 10/700,978

(22) Filed: Nov. 4, 2003

Related U.S. Application Data
(60) Provisional application No. 60/423,486, filed on Nov. 4, 2002.

(51) Int. Cl. A01M 1/00

(52) U.S. Cl. 43/1

(57) ABSTRACT

A device for holding an odor-producing repellent. The device comprises two oppositely disposed compartments for holding the repellent and a pair of substantially parallel strips connecting the pods together. Each pod includes a cap for enclosing each pod and a plurality of slots on both the pods and the caps for allowing the odor-repellent to be released into the immediate atmosphere. The device is flexible and can be secured to a treebranch by twisting one pod and placing it between and through the connecting strips. Once through, the pod is secured in place and cannot return through the strips, thereby securing the device to a treebranch.

### CROSS REFERENCE TO RELATED APPLICATION

This application claims the benefit of U.S. Provisional Application No. 60/423,486, filed Nov. 4, 2002, under Title 35, United States Code, Section 119(e).

### FIELD OF THE INVENTION

The present invention relates generally to a device for holding and emitting a substance that serves as an animal repellent. More particularly, the present invention is a device for housing an animal repellent that is able to be secured around a fixed object outdoors.

### DESCRIPTION OF THE PRIOR ART

There exists in the art many devices that serve the purpose of hanging or securing an object from or to another object. There also exists in the art hanging devices for providing a repellent for animals or insects in order to repel those animals or insects away from a particular location or area. Animal and insect repellants are desirable in order to maintain and ensure the safety, health and well being of adults, children and pets that are present in that particular area. Such unwanted animals often times carry fleas and ticks or other insects that can cause disease in humans and pets. Those same animals and insects also often times transport other diseases, such as west Nile virus, rabies, malaria, etc. that can seriously harm, or even kill, humans and pets. Such repellants are also desirable in order to prevent unwanted animals or insects from trekking onto a garden or other area of foliage growth, where those animals or insects may potentially disturb or destroy the plants, vegetables, fruit, flowers, etc. that are being cultivated in that area.

A variety of devices and methods currently exist which repel animals from a particular area. Such devices and methods include scarecrows (both stationary and robotic), odor emitters, such as in the form of pellets where the animal being repelled associates the odor with a predator, sprays and organic sprays, such as hot pepper wax which is made from extracted hot cayenne pepper and combined with food-grade wax, and an oil mix or spray repellent that can be applied directly onto a pet or person.

Various problems exist with such methods. For example, with scarecrows, animals are either not deterred at all or else become acclimated to them over time and learn that the device is not a threat and thus, in time, are no longer deterred. Sprays can be washed away by rainwater or can be blown away by the wind. Oils and sprays that are applied to a person or pet are troublesome in that they can be an irritant and will ultimately have to be washed off, which can be a nuisance in that a residue may be leftover. They can also get on or stain clothing and can cause undesirable odors at inopportune times. Repellents in the form of pellets tend to quickly deteriorate due to handling and the weather elements, such as rain, snow and wind. Many of these devices are also directly applied to either the ground, plants or elsewhere on the area being protected from unwanted animals and insects. This direct exposure to the elements facilitates the breakdown of these devices.

### SUMMARY OF THE INVENTION

The present invention is directed to a device for providing a repellent, such as an odor-producing repellent, for discouraging the presence of particular animals and/or insects from a desired area. The present invention is further directed to a device for sufficiently protecting the odor producing repellent from the weather elements while maintaining sufficient amounts of odor to the surrounding atmosphere.

According to the present invention, a device is provided having at least one, and preferably two, oppositely placed reservoirs, or pods, into which may be placed a repellent that provides an odor that repels animals or insects from a particular location. The pods are connected by two parallel, flexible, resilient strips that can be easily bent. The reservoirs, or pods, have variably placed slots or vents to allow the escape of the odor from within the pods. A removable cap is provided for capping the pod in order to prevent children, insects or animals from accessing the substances held within the pod. The cap also is provided with a plurality of vents so as to not impede the of the odor repellent generated within the pod. The odor is ideally generated by providing a stable substance, such as paraffin or a gel, having been impregnated with essential oils for producing aromas, odors, scents and the like. The paraffin or gel itself is anchored into the reservoir by means of an anchoring mechanism on the bottom of the pod, such as a knob, which extends upwardly from the bottom of the pod. The scent-producing substance is formed around the knob where it hardens, thereby securing the substance in the pod.

The device according to the present invention is adapted so as to be easily placed outside, such as hung from or otherwise secured to a treebranch or a fence. The device can be wrapped around a treebranch and one pod is placed through the parallel strips thereby securing the device around the branch. In addition, gutters are employed on each pod to prevent rain water from accumulating on the cap or pod and dripping into the pod itself.

It is an object of the invention to provide a device for repelling animals and/or insects from a desired area.

It is another object of the present invention to provide a device for holding a stable substance having an impregnated scent producing material therein.

It is yet another object of the present invention to provide a device for repelling animals or insects from a particular location that can be employed outdoors.

It is still yet another object of the present invention to provide a device that can be easily secured to a tree, post, fence and the like.

It is another object of the present invention to provide a device for holding an insect or animal repellent that is inexpensive.

It is yet another object of the present invention to provide a device for holding an insect or animal repellent that is easily accessible for placement of the repellent inside the device, but not easily accessible for animals or children.

Still yet another object of the present invention is to provide a device for holding a scent-producing animal or insect repellent that is highly impervious to the weather elements.

### BRIEF DESCRIPTION OF THE DRAWINGS

FIG. 1 is a top view of the device of the present invention.

FIG. 2 is a bottom view of the device shown according to the present invention.

FIG. 3 is a top view of a cover for employment with the device of the present invention.

FIG. 4 is a top view of a single, uncovered pod of the present invention.

FIG. 5 is a cross sectional view of a single pod of the present invention as shown in FIG. 1.

FIG. 6 is a top, operational view of the cover shown in FIG. 3 and a single pod according to the present invention.

FIG. 7 is a perspective view of the device according to the present invention, showing one mode of operation.

FIG. 8 is a perspective view of the device according to the present invention, showing an alternative mode of operation.

FIG. 9 is a perspective view of the device according to the present invention showing an additional alternative mode of operation.

FIG. 10 is a top view of an alternative embodiment of the device according to the present invention.

### DETAILED DESCRIPTION OF THE PREFERRED EMBODIMENTS

The present invention is now described with reference to the drawings, wherein like reference numerals are used to refer to like elements throughout. In the following description, and for purposes of explanation, numerous specific details are set forth in order to provide a thorough understanding of the present invention. It will be evident, however, to one skilled in the art that the present invention may be practiced without these specific details.

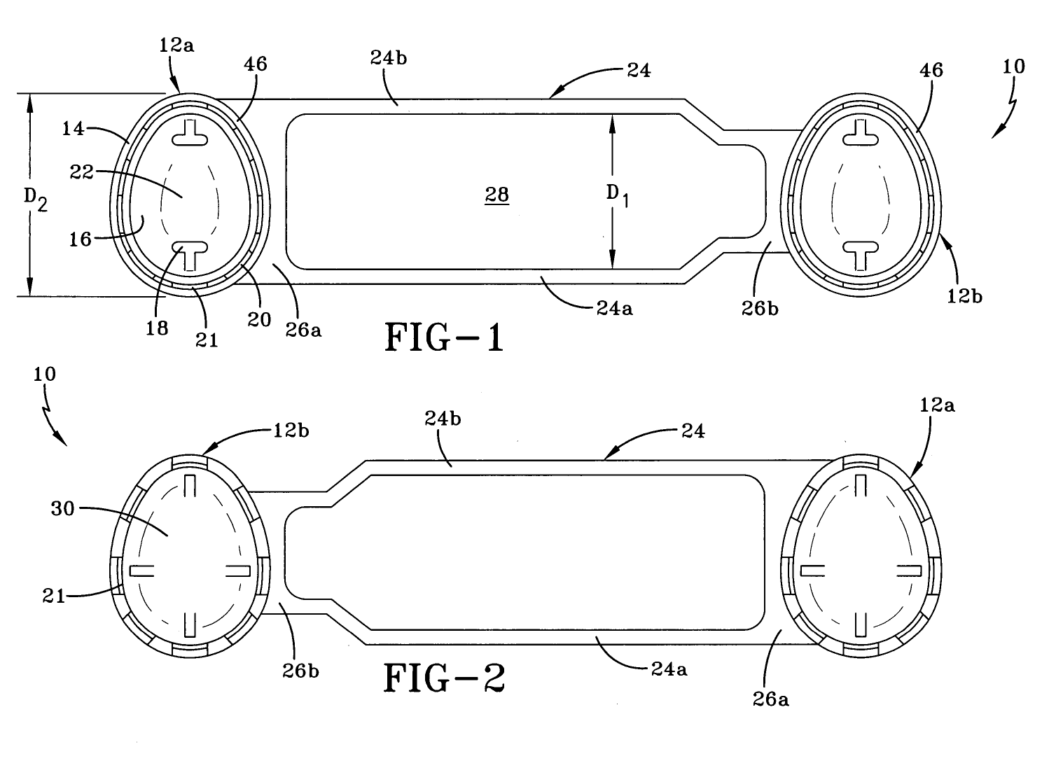

Referring now to FIGS. 1 and 2, the device of the present invention is shown and referred to generally at numeral 10. Device 10 comprises a first compartment or pod 12a disposed opposite from a second compartment or pod 12b. For purposes of explanation herein, device 10 is shown as having two pods 12a and 12b disposed opposite from each other; however it should be appreciated that any number of additional pods can be employed being placed adjacent to pods 12a and 12b in an outwardly spaced manner. In addition, for purposes of explanation, only one pod will be described; but it should be appreciated that the pod disposed oppositely therefrom contains substantially the same elements and details that pertain to the pod being described herein.

Pod 12a comprises an upper ridge 14 having a substantially ovoid shape which defines the shape of pod 12a. Of course ridge 14 and pod 12a can have any other shape, such as oval, circle, square, etc. A substantially circular inner sidewall 16 extends downwardly from upper ridge 14 and converges at a bottom wall 22 of pod 12a. Bottom wall 22 comprises the floor of pod 12a and has an underside 30 (FIG. 2) that is preferably flat, but can be curved or also have any other appropriate shape known in the art. In addition, pod 12a can be of any size so that it can be easily placed and secured to an object outside, such as a treebranch, fence or post. In addition, device 10 can be made of any material known in the art, such as a thermoplastic.

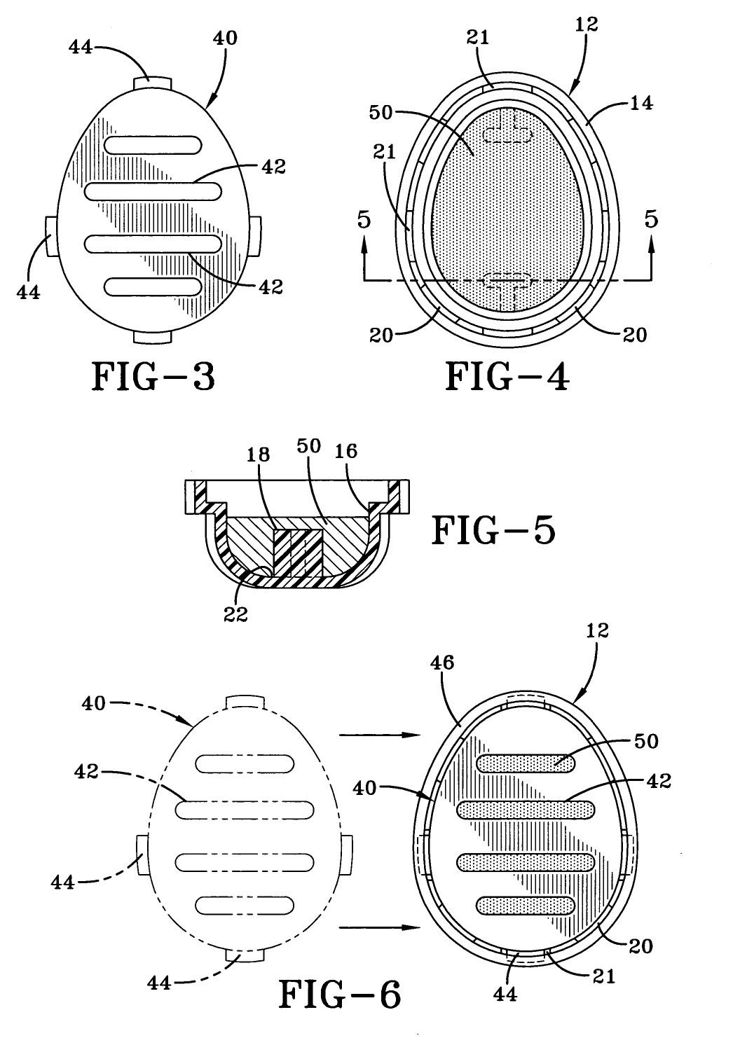

Pod 12a further comprises a plurality of slots placed on the upper portion of sidewall 16 near ridge 14. Some slots, denoted at numeral 21, are slots for engaging a tab 44 (FIG. 3) located on a cap 40 (FIG. 3) for locking cap 40 into place on pod 12a. Tab 44 and cap 40 will be described in more detail below. Additional slots, denoted at numeral 20, are also located on the upper portion of sidewall 16 near upper ridge 14. Slots 20 facilitate the exit of the repelling scent that is generated and released from inside pod 12a into the surrounding atmosphere and do not help secure cap 40 in place on pod 12a.

Still referring to FIG. 1, a connecting member 26a is provided on the outside of sidewall 14. Extending outwardly from connecting member 26a is a pair of parallel strips 24a and 24b, collectively referred to at numeral 24. Pair of parallel strips 24 extends outwardly and connects to a second connecting member 26b located on second pod 12b, which, as stated supra, is disposed opposite from first pod 12a. Any distance between strip 24a and 24b may be employed, such as the distance demonstrated at D₁. However, it is preferable that the distance between strip 24a and strip 24b be less than the length of pod 12a, where that length is shown at numeral D₂. As will be explained later, the distance between strip 24a and strip 24b should be such that one of the pods, such as pod 12b, can be easily twisted by twisting strips 24 and can be slipped through the space that is defined by strips 24. Pod 12b can then be straightened to its original position thereby locking it in place so that it cannot slip back through strips 24. This construction allows device 10 to be easily looped and secured around an object such as a treebranch. In addition, a gutter 46 is provided on pod 12a for diverting the flow of water away from pod 12a so that water may not accumulate on pod 12a.

Turning now to FIG. 3, as stated above, device 10 comprises a cap 40 that is provided for each pod 12a or 12b. Cap 40 can be secured onto and cover pod 12a so that the repellent therein is maintain inside pod 12a and so that children or other animals not affected by the repellent are not able to come into contact with the repellent. Cap 40 additionally comprises a plurality of vents 42 for allowing the scent generated by the repellent inside pod 12a to escape into the surrounding atmosphere. Lid 40 is shown having 4 substantially oval vents 42, however any number of vents having any shape and configuration may be employed.

Turning now to FIGS. 4 and 5, device 10 having a repellent 50 situated therein will now be described. Repellent 50 is secured in pod 12a by being formed around a nodule or anchor 18. Once repellent 50 harden in place, anchor 18 maintains a secure engagement with repellent 50 so that repellent 50 does not become displaced from the outside elements, such as wind.

The repellent 50 itself that is employed can be any typical odor-creating substance known in the art that creates a smell that is repulsive to either animals or insects or both and is formed within a solid structure. It should be appreciated that smell is the effective means of device 10. For example, repellent 50 itself can be a blend of impregnated paraffin having essential oils or it can be an impregnated gel with essential oils. Such essential oils for generating scent are common in the fragrance industry, such as Cymbopogon flexuosus (lemon grass) or an oil from the Brassicaceae family of plants, such as mustard oil. Of course the oils can be either naturally occurring or synthetically fabricated. It is the aroma of the essential oils that serves as the repellent.

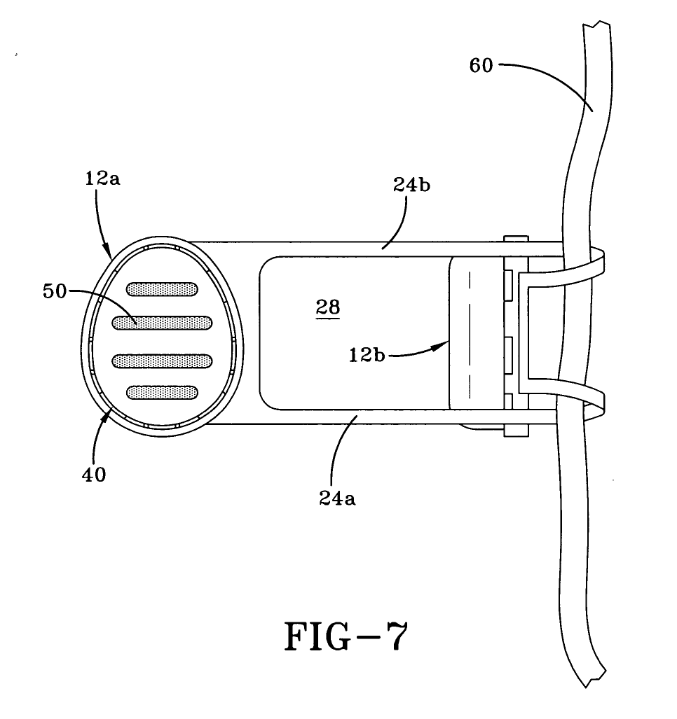

Turning now to FIG. 6, the placement of cap 40 onto pod 12 is shown. After repellent 50 has been secured within pod 12, cap 40 (shown in ghost form) is taken and placed onto pod 12. Tabs 44 snap into place with corresponding slots 20 so that cap 40 is adequately secured on pod 12, thereby ensuring that repellent 50 is safely secured inside pod 12. Of course cap 40 can be easily removed by displacing tab 44 from its respective slot 20. With cap 40 removed, pod 12 can be cleaned and refilled with a new supply of repellent 50.

Turning now to FIG. 7, device 10 of the present invention is shown in one mode of operation. Device 10 is placed adjacent to a treebranch 60 to which it is desired that device 10 be secured. Pod 12b is twisted and moved around branch 60 so that pair of parallel strips 24 create a substantial loop around branch 60. Pod 12b, having been twisted approximately 45°, is able to easily be slipped through the space 28 that is defined by parallel strips 24. Upon completely traversing space 28, pod 12b is returned to substantially its original configuration so that it can not come back through space 28. With pod 12b being locked in place, device 10 is secured to treebranch 60 and repellent 50 inside each of pod 12a and 12b can be efficiently utilized.

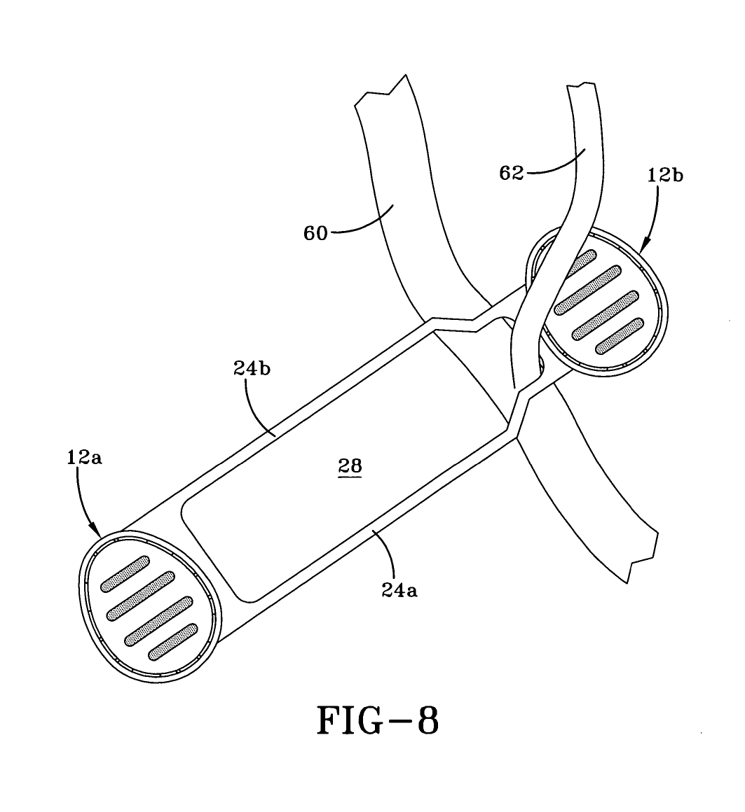

Turning now to FIG. 8, an alternative mode of employment of the device of the present invention is shown and described. In this mode, either pod 12a or 12b is secured over a small branch 62 that extends off a larger branch 60. In other words, pair of parallel strips 24 acts as a hooking apparatus and is hooked over branch 62. Branch 62 extends through space 28, thereby securing device 10 to the tree and allowing for efficient utilization of repellent 50 inside each of pod 12a and 12b. It should be appreciated that although device 10 of the present invention was illustrated in combination with a treebranch, it can be employed with any other outdoor fixture, such as a fence post, doorway, etc.

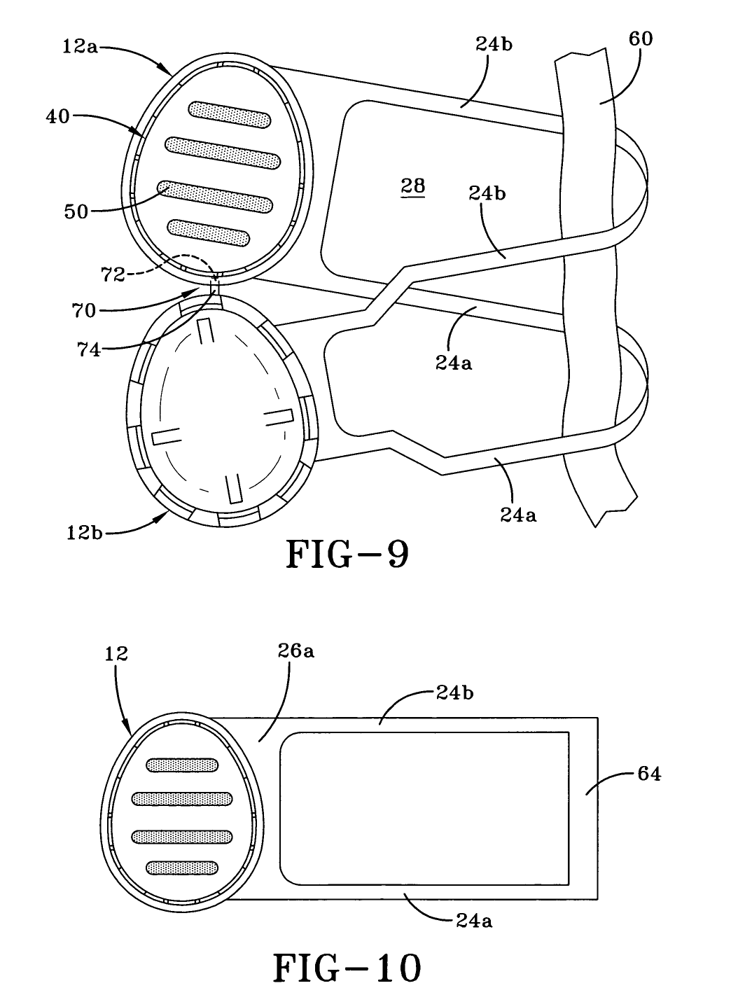

Turning to FIG. 9, yet another alternative mode of the present invention is shown and described. In this mode of operation, device 10 includes the same features as described above. Device 10 further includes a rivet assembly 70 (or any other comparable securing device) having a female portion 72 and a male portion 74, one being on pod 12a and the other being on pod 12b. Device 10 is wrapped around a branch 60 and rivet assembly 70 is secured by the engagement between female portion 72 and male portion 74, thereby securing device 10 to the branch 60.

Turning lastly to FIG. 10, an alternative embodiment of the present invention is shown and described. In this embodiment, each of the features of device 10 described above are included. However, device 10, in this embodiment, only includes one pod 12. Just as described above, a first connecting member 26a is secured to the side of pod 12 and a pair of parallel strips 24a, 24b extend outwardly from first connecting member 26a. Rather than extending towards a second connecting member 26b, and in turn a second pod 12b, as above, strips 24a, 24b extend towards a securing band 64. Securing band 64 is preferably the same material as strips 24a, 24b and is perpendicular to strips 24a, 24b. In turn, band 64 is parallel to connecting member 26a. In this embodiment, device 10 functions in the same manner as above and can be secured to a treebranch, fence and the like in any of the same manners as described above.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

What is claimed is:

1. A device for holding an odor-producing repellent comprising:
at least two oppositely disposed compartments for holding said repellent, said at least two compartment comprising an annular ridge, a floor at the bottom of each compartment, a circular sidewall extending downwardly from said ridge to said floor and at least one slot between said ridge and said sidewall; and
a pair of substantially parallel strips extending outwardly from a first of said at least two compartments and connecting said first compartment to a second of said at least two compartments, said strips defining a space therebetween;
wherein said at least one slot on each of said at least two compartments facilitate the transmission of the odor from said odor-producing repellent from said at least two compartments into the atmosphere.

2. The device according to claim 1 wherein the odor of said odor-producing repellent is a scent blended with a congealing substance, said congealing substance is selected from the group consisting of an impregnated paraffin having essential oils or an impregnated gel having essential oils.

3. The device according to claim 1 wherein said at least two compartments have a shape selected from the group consisting of ovoid, oval, circular, triangular, square, rectangular, octagonal and polygonal.

4. The device according to claim 1 and further comprising a removable cap on each of said at least two compartments, said cap comprising an annular and at least one tab extending outwardly from said rim for securing to a corresponding slot of said at least one slot on each compartment of said at least two compartments.

5. The device according to claim 4 wherein said cap further comprises at least one orifice for facilitating the transmission of said odor from inside said at least two compartments.

6. The device according to claim 5 wherein said cap has a shape that substantially corresponds to said at least two compartments.

7. The device according to claim 1 wherein said pair of parallel strips are comprised of a bendable, resilient plastic.

8. The device according to claim 7 wherein said bendable, resilient plastic is selected from the group consisting of polyethylene, polypropylene, poly vinyl chloride, polystyrene, acrylics, nylons, cellulosics, flouroplastics and polyester.

9. The device according to claim 1 wherein said at least two compartments further comprise at least one nodule extending upwardly from said floor of said at least two compartments for anchoring said congealing substance within each compartment of said at least two compartments.

10. The device according to claim 1 wherein said device can be hung from a treebranch.

11. The device according to claim 1 wherein said device can be hung from a tree by twisting one of said at least two compartments around a tree branch and placing said compartment through said space of said parallel strips.

12. The device according to claim 1 wherein said essential oil is selected from the group consisting of Cymbopgon flexuosus and any oil of the Brassicaceae family of plants, such as mustard oil.

13. The device according to claim 1 wherein said repellent is at least one of an animal repellent and an insect repellent.

14. A device for holding an odor-producing repellent comprising:
a compartment for holding said repellent, said compartment comprising an annular ridge, a floor at the bottom of said compartment, a circular sidewall extending downwardly from said ridge to said floor and at least one slot between said ridge and said sidewall;
a securing band oppositely disposed from said compartment; and
a pair of substantially parallel strips extending outwardly from said compartment to connect said compartment to said securing band, said strips defining a space therebetween;
wherein said at least one slot on each of said at least two compartments facilitate the transmission of the odor from said odor-producing repellent from said at least two compartments into the atmosphere.
